(19) United States
(12) Patent Application Publication
(10) Pub. No.: US 2025/0125932 A1
(43) Pub. Date: Apr. 17, 2025

(54) SIGNALING FOR PULSE SHAPING

(71) Applicant: Samsung Electronics Co., Ltd., Suwon-si (KR)

(72) Inventors: Soheil Rostami, Carrollton, TX (US); Joonyoung Cho, Portland, OR (US); Ravindranath Kanamangala, Murphy, TX (US)

(21) Appl. No.: 18/791,316

(22) Filed: Jul. 31, 2024

Related U.S. Application Data
(60) Provisional application No. 63/544,564, filed on Oct. 17, 2023.
(60) Provisional application No. 63/557,687, filed on Feb. 26, 2024.

(51) Int. Cl. H04L 5/00; H04L 25/03; H04W 72/51

(52) U.S. Cl. CPC H04L 5/0053; H04L 5/001; H04L 25/03853; H04W 72/51

(57) ABSTRACT

Methods and apparatuses for signaling pulse shaping in a wireless communication system. A method of BS includes determining a spectral extension index (SEIndex) and a frequency domain spectral shaping type index (FDSSTypeIndex) for at least one transmission time interval (TTI) and transmitting, to a UE, the SEIndex and the FDSSTypeIndex. The method further includes receiving, from the UE, uplink (UL) data based on a spectral extension (SE) ratio associated with the SEIndex and frequency domain spectral shaping (FDSS) values. The FDSS values are associated with the FDSSTypeIndex.

### CROSS-REFERENCE TO RELATED APPLICATIONS AND CLAIM OF PRIORITY

The present application claims priority to U.S. Provisional Patent Application No. 63/544,564, filed on Oct. 17, 2023, and U.S. Provisional Patent Application No. 63/557,687, filed on Feb. 26, 2024. The contents of the above-identified patent documents are incorporated herein by reference.

### TECHNICAL FIELD

The present disclosure relates generally to wireless communication systems and, more specifically, the present disclosure relates to signaling pulse shaping in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to signaling pulse shaping in a wireless communication system.

In one embodiment, a base station (BS) in a wireless communication system is provided. The BS comprises a processor configured to determine a spectral extension index (SEIndex) and a frequency domain spectral shaping type index (FDSSTypeIndex) for at least one transmission time interval (TTI). The BS further comprises a transceiver operably coupled to the processor, the transceiver configured to transmit, to a UE, the SEIndex and the FDSSTypeIndex, and receive, from the UE, uplink (UL) databased on a spectral extension (SE) ratio associated with the SEIndex and frequency domain spectral shaping (FDSS) values, wherein the FDSS values are associated with the FDSSTypeIndex.

In another embodiment, a method of BS in a wireless communication system is provided. The method comprises determining an SEIndex and an FDSSTypeIndex for at least one TTI; transmitting, to a UE, the SEIndex and the FDSSTypeIndex; and receiving, from the UE, UL data based on an SE ratio associated with the SEIndex and FDSS values, wherein the FDSS values are associated with the FDSSTypeIndex.

In yet another embodiment, a UE in a wireless communication system, the UE comprises a transceiver configured to receive, from a BS, an SEIndex and an FDSSTypeIndex. The UE further comprises a processor operably coupled to the transceiver, the processor configured to identify the SEIndex and the FDSSTypeIndex for at least one TTI, and wherein the transceiver is further configured to transmit, to the BS, UL data based on an SE ratio associated with the SEIndex and FDSS values associated with the FDSSTypeIndex.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of Tx architecture for FDSS-DFT-S-OFDM and spectral extension operation according to embodiments of the present disclosure;

FIG. 7 illustrates an example of Rx architecture for FDSS-DFT-S-OFDM and combiner operation according to embodiments of the present disclosure;

FIG. 8 illustrates a flowchart of UE capability exchange for FDSS based on an RRC message according to embodiments of the present disclosure;

FIG. 9 illustrates an example of joint operation of FDSS selection and scheduler in uplink according to embodiments of the present disclosure;

FIG. 10 illustrates a flowchart of RRC signaling to configure/reconfigure FDSSTypeIndex and SEIndex according to embodiments of the present disclosure;

FIG. 11 illustrates a signaling flow of RRC signaling to configure/reconfigure FDSSTypeIndex and SEIndex according to embodiments of the present disclosure;

FIG. 12 illustrates a flowchart of RRC signaling to enable FDSSTypeIndex and SEIndex according to embodiments of the present disclosure;

FIG. 13 illustrates a flowchart of MAC-CE signaling to configure FDSSTypeIndex and SEIndex according to embodiments of the present disclosure; and

FIG. 14 illustrates a flowchart of a BS method for signaling pulse shaping in a wireless communication system according to embodiments of the present disclosure.

### DETAILED DESCRIPTION

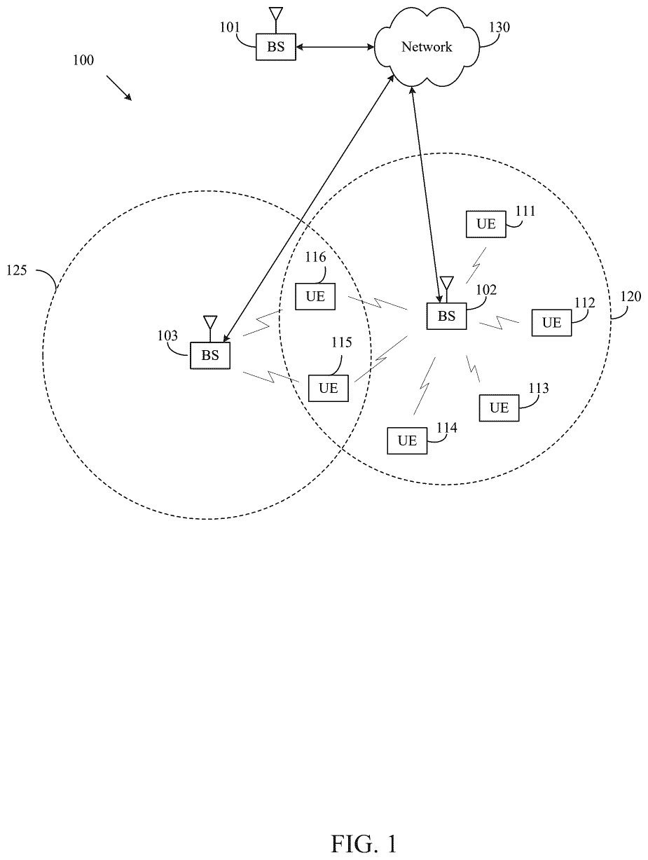

FIGS. 1-14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for signaling pulse shaping in a wireless communication system. In certain embodiments, and one or more of the gNBs 101-103 includes circuitry, programing, or a combination thereof, for supporting signaling pulse shaping in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

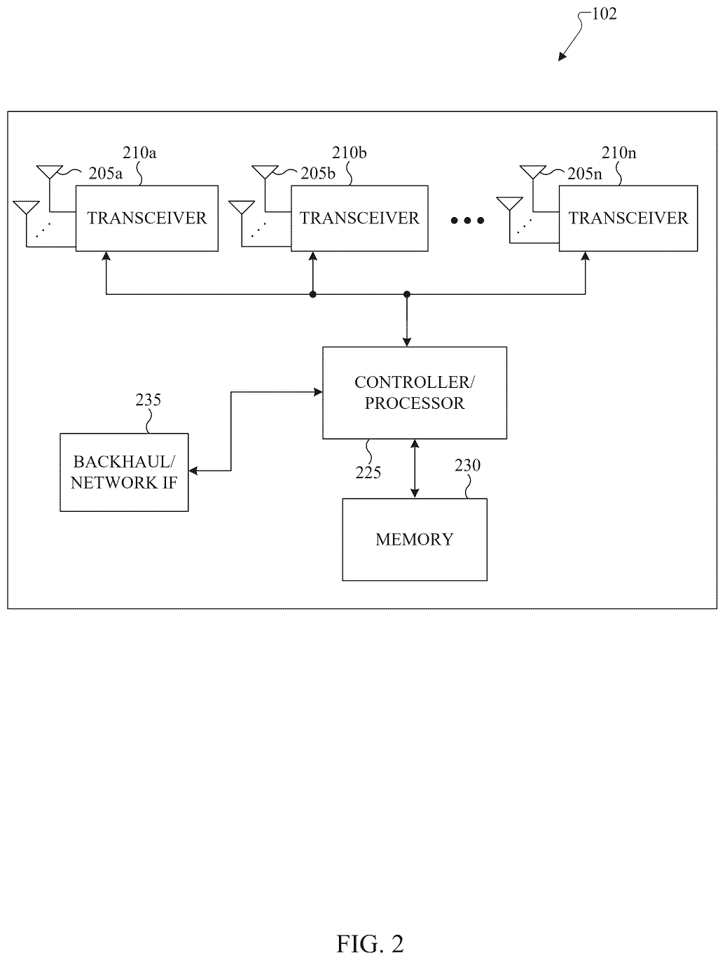

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting signaling pulse shaping in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

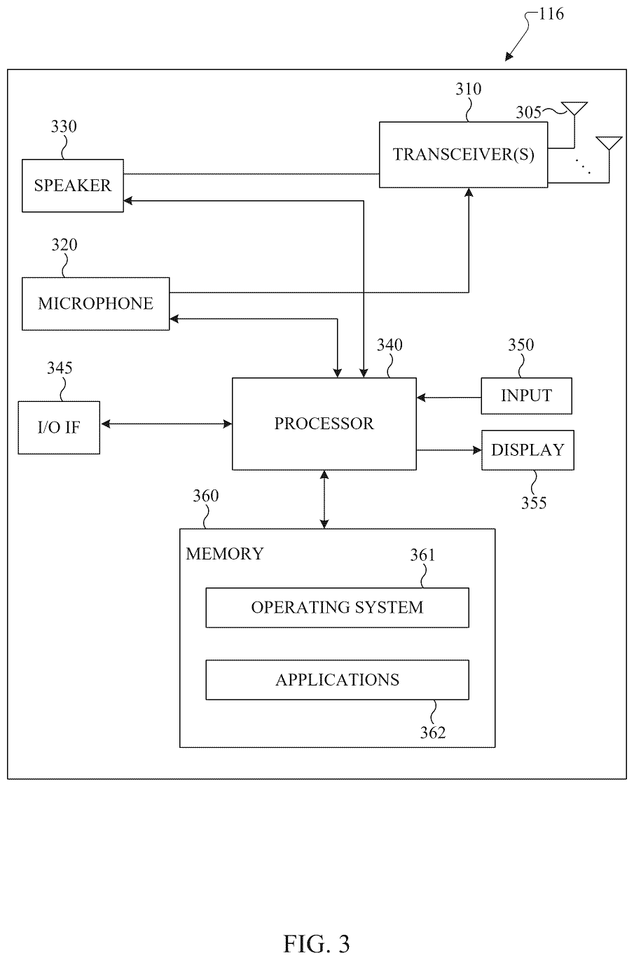

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for signaling pulse shaping in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

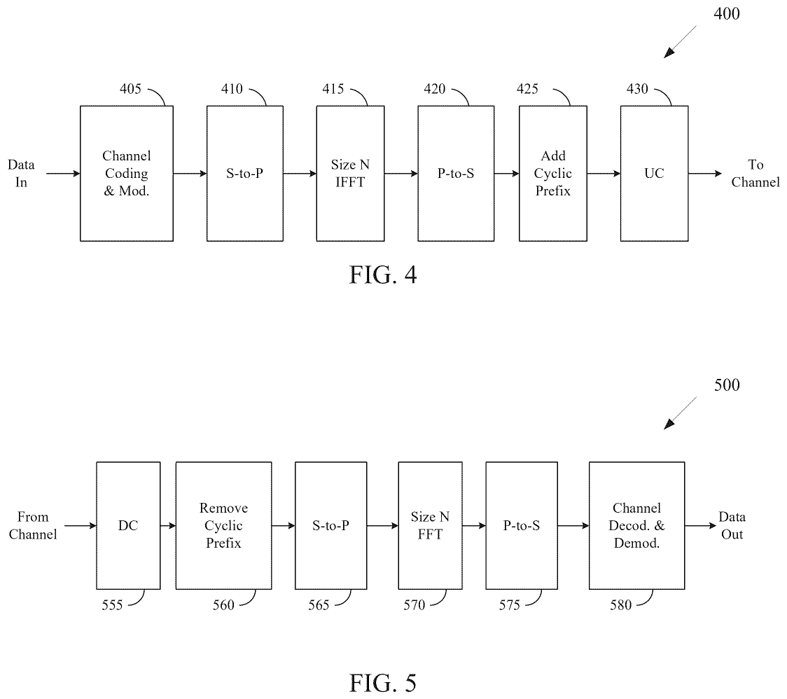

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support signaling pulse shaping in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A discrete Fourier transform spreading OFDM (DFT-s-OFDM) is a single carrier waveform with low peak-to-average power ratio (PAPR) and could be a promising candidate waveform for B5G and 6G systems. Improving PAPR of DFT-s-OFDM may enhance power amplifier efficiency, an uplink coverage range and power consumption of UEs.

There are different PAPR reduction techniques for DFT-s-OFDM (such techniques may introduce signal distortion and sacrifice spectral efficiency). Among them, a pulse shaping (also known as spectrum shaping) is known as a data-independent and low-complexity technique to reduce DFT-s-OFDM's PAPR at the cost of spectral extension (additional required subcarriers) and potentially higher symbol-error rate (SER).

Frequency domain spectrum shaping (FDSS) and time domain spectrum shaping (TDSS) are two equivalent solutions to implement spectrum shaping. However, due to DFT-s-OFDM, a frequency domain spectral shaping (FDSS) method is a more computationally-efficient and flexible. Moreover, the power of the side-lobes for FDSS is lower than the TDSS.

A basic pulse shaping without spectral extension has been defined in 5G (since Rel-15) for π/2-BPSK, while the exact pulse shape is not defined in the specifications. It can be shown that by using spectral extension, the pulse-shaping can achieve much better PAPR performance.

The discrete Fourier transform spreading OFDM (DFT-s-OFDM) has been adopted and commercialized as a key uplink waveform for the 3GPP 4G/5G mobile communication systems and widely regarded as the baseline waveform of B5G/6G systems.

In DFT-s-OFDM, the application of DFT spreading operation prior to subcarrier mapping spreads the signal's energy across subcarriers, effectively achieves lower peak-to-average power ratio (PAPR) compared to OFDM and improves power amplifier efficiency and reduces the risk of distortion. The pulse shaping filter is preceded by the spectral extension (SE) operation to reduce PAPR at the expense of the spectral extension.

While DFT-s-OFDM offers notable advantages, selecting the pulse shaping filter and spectral extension (SE) ratio can achieve a desired tradeoff between symbol error rate (SER), PAPR, and spectral flatness requirements. Basic pulse shaping without spectral extension has been defined in 5G for π/2-BPSK, while the exact pulse shape is not defined in the specifications.

To exploit the advantages of pulse shaping, it is essential that a UE and a BS know the exact filter taps and spectrum extension ratio in which is utilized for given uplink scheduling. Therefore, signaling between the UE and the BS for enabling/disabling as well as configuring/reconfiguring FDSS is needed to dynamically and statically control FDSS-DFT-s-OFDM operation among UEs.

The present disclosure is to introduce and modify signaling between a UE and a BS for enabling/disabling as well as configuring/reconfiguring FDSS filter and spectral extension ratio, dynamically and statically by introducing new information element fields to RRC and PDCCH as well as MAC-CE. The FDSS-DFT-s-OFDM enables the synthesis of block-based single carrier waveforms with a learned FDSS (e.g., AI approach) over various SE ratios and bandwidths (number of RBs). The signaling enables to apply any pre-defined and specified pulse shape (reference pulse shape specified in standard) for arbitrary number of scheduled resource blocks (RBs).

The present disclosure defines multiple look-up tables (RB dependent and RB independent) to specify the feasible spectral extension ratios, and how they can be mapped to spectral extension ratios. Furthermore, frequency domain spectral shaping (FDSS) selector could be defined in network side to select the corresponding FDSS parameters to achieve desired PAPR and symbol error rate (SER).

FDSS-DFT-S-OFDM offers backward compatibility with 4G/5G (rectangular pulse shaping without SE), while striking better SER, PAPR, complexity and spectral flatness requirements. Low implementation complexity and small modification of original architecture of DFT-s-OFDM can make FDSS-DFT-s-OFDM a waveform candidate for B5G and 6G systems.

The embodiments of the disclosure are applicable in general to any communication system.

Modulated (e.g., π/2 BPSK, QPSK) block of N_{data} symbols x=[x₁, . . . , x_{N}_{_{data}}] is converted into the symbol block in frequency domain as X=[X₁, . . . , X_{N}_{_{data}}] by DFT with length N_{data}.

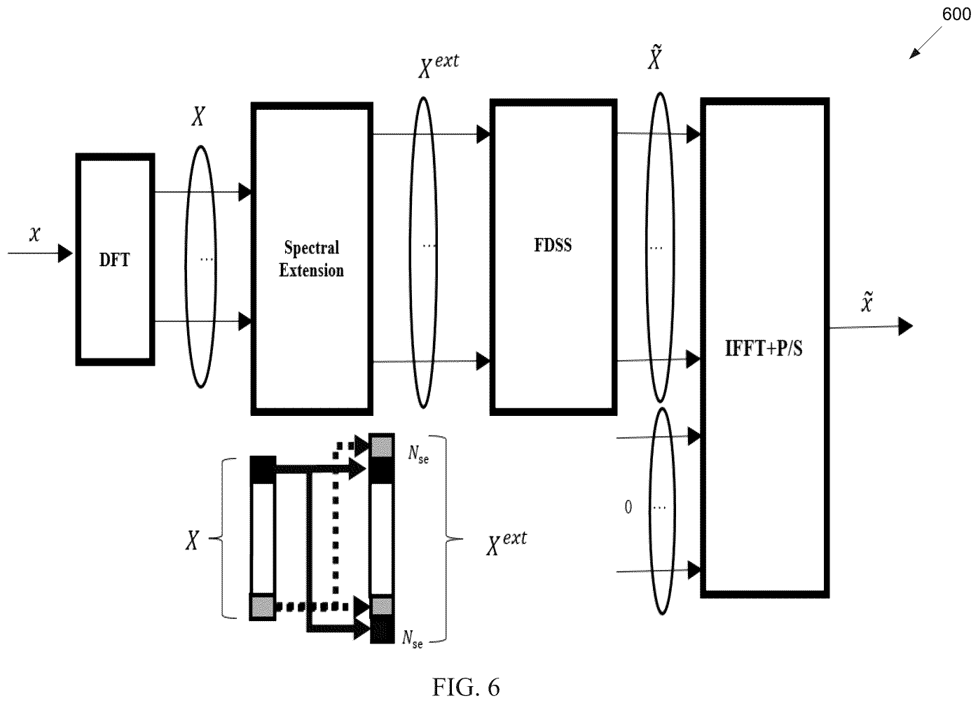

FIG. 6 illustrates an example of Tx architecture 600 for FDSS-DFT-S-OFDM and spectral extension operation according to embodiments of the present disclosure. An embodiment of the Tx architecture 600 shown in FIG. 6 is for illustration only.

FIG. 6 is an example of signal processing block diagram at Tx side to generate FDSS-DFT-s-OFDM signal for input symbols x. It can be shown that the output of IFFT (\tilde{x}) is equivalent to time domain version of filtered signal of DFT-S-OFDM.

The DFT symbol block is circularly extended to a symbol block with length N_{sc} as X^{ext}=[X₁^{ext}, . . . , X_{N}_{_{sc}}^{ext}]=[X_{N}_{_{data}}_{-N}_{ₛₑ}₊₁, . . . , X_{N}_{_{data}}, X₁, . . . , X_{N}_{_{data}}, X₁, . . . , X_{N}_{ₛₑ}], where 2Nₛₑ is the number of extended subcarriers and N_{sc}=N_{data}+2Nₛₑ is the total number of subcarriers. Spectral extension (SE) ratio is defined as

$$SE = \frac{2 {N}_{se}}{{N}_{data}} = \frac{2 {N}_{se}}{{N}_{sc} - 2 {N}_{se}} ,$$

ranging from 0 (no spectral extension) to 1 (100% spectral extension).

The symmetrically extended DFT symbol block with length N_{sc} goes through the FDSS filter with the tap values of F=[F₁, . . . Fₖ, . . . , F_{N}_{_{sc}}], where Fₖ is frequency domain filter tap corresponding to k^{th} subcarrier. This could be achieved by computationally-efficient operation of element wise multiplication \tilde{X}=X^{ext}⊙F.

The filtered symbol block \tilde{X} is mapped to the scheduled subcarriers and is converted into the OFDM symbol in time domain by IFFT with length of N_{fft} as \tilde{x}=[\tilde{x}₁, . . . , \tilde{x}_{N}_{_{fft}}], and the CP is attached for transmission by UE.

The operation of DMRS is similar to the operation of data from the spectrum extension module, where a UE applies same FDSS for both data and DMRS.

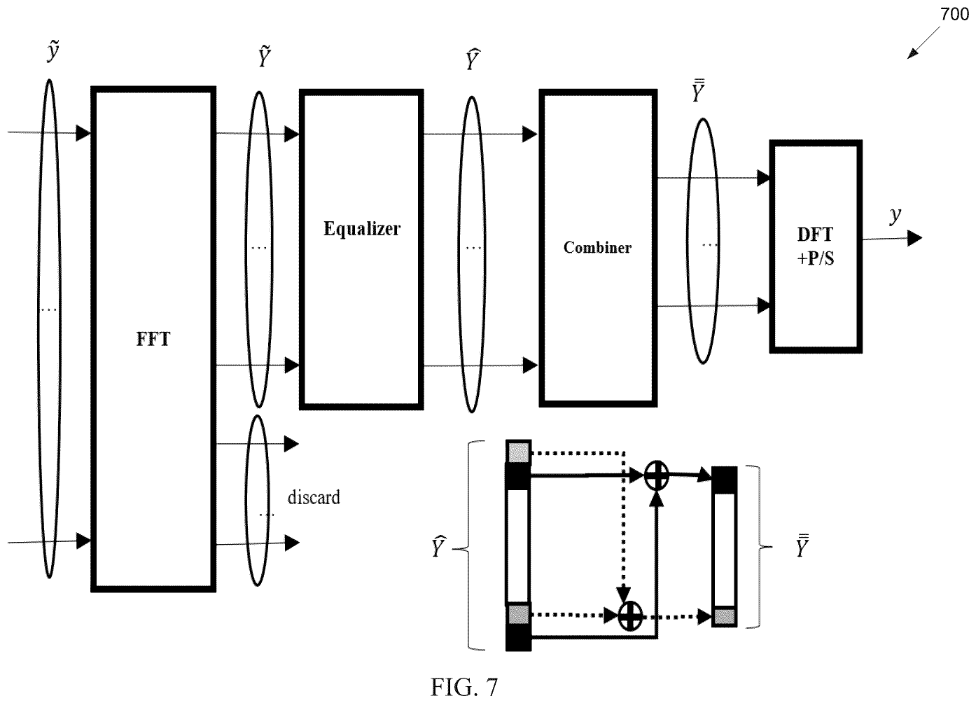

The receiver (e.g., gNB) removes the CP of the received OFDM symbol, obtains the samples with length N_{fft} as \tilde{y}=[\tilde{y}₁, . . . , y_{N}_{_{fft}}], then converts the samples into the symbol block in frequency domain and extracts corresponding number of subcarriers with length N_{sc}, i.e., \tilde{Y}=[Y₁, . . . , \tilde{Y}_{N}_{_{sc}}]. FIG. 7 is an example of signal processing block diagram at Rx side to demodulate FDSS-DFT-S-OFDM.

FIG. 7 illustrates an example of Rx architecture 700 for FDSS-DFT-S-OFDM and combiner operation according to embodiments of the present disclosure. An embodiment of the Rx architecture 700 shown in FIG. 7 is for illustration only.

Moreover, the receiver equalizes the symbols on scheduled subcarriers with element wise multiplication,

$$\hat{Y} = \tilde{Y} ⊙ \frac{{F}^{*}}{{\vert \tilde{F} \vert}^{2}}$$

where F* is conjugate of F and \tilde{F}=[F_{N}_{ₛₑ}₊₁+F_{N}_{_{sc}}_{-N}_{ₛₑ}₊₁, . . . , F_{2N}_{ₛₑ}+F_{N}_{_{sc}}, F_{2N}_{ₛₑ}₊₁, . . . , F_{N}_{_{sc}}_{-2N}_{ₛₑ}, F_{N}_{_{sc}}_{-2N}_{ₛₑ}₊₁+F₁, . . . , F_{N}_{_{sc}}_{-N}_{ₛₑ}+F_{N}_{ₛₑ}].

After equalization, to obtain the DFT symbol block with length N_{data}, the corresponding symbols on the spectrum extension and data subcarriers can be combined as schematic is shown in FIG. 7 and can be expressed as follows: Y̅=[Ŷ_{N}_{ₛₑ}₊₁+Ŷ_{N}_{_{sc}}_{-N}_{ₛₑ}₊₁, . . . , Ŷ_{2N}_{ₛₑ}+Ŷ_{N}_{_{sc}}, Ŷ_{2N}_{ₛₑ}₊₁, . . . , Ŷ_{N}_{_{sc}}_{-2N}_{ₛₑ}, Ŷ_{N}_{_{sc}}_{-2N}_{ₛₑ}₊₁+Ŷ₁, . . . , Ŷ_{N}_{_{sc}}_{-N}_{ₛₑ}+Ŷ_{N}_{ₛₑ}].

The DFT symbol block with length N_{data}, Y̅ is converted into the modulated symbol block in a time domain with IDFT length N_{data}, y=[y₁, . . . , y_{N}_{_{data}}].

A feasible range of spectral extension (SE) ratio is dependent on a number of scheduled resource blocks (RBs) (equivalently number of subcarriers). When the number of resource blocks (RBs) is small, the possible number of SE ratio is limited. However, for larger values of RBs, more diverse range of SE ratio could be realized. With the number of RB (referred to as i), (3i+1) different SE ratio between SE ratio 0 and 1 is feasible. For instance, with the number of RB i=1, there are 4 different SE ratios available (0,1/5,1/2,1), and SE ratio 1/5 is the smallest none-zero ratio that is feasible. However, with the number of RB of 3, there are 10 feasible SE ratios and the smallest none-zero SE ratio is 1/11. Therefore, depending on number of scheduled RBs, different SE ratios (SE) could be achieved.

“SEIndex” can be defined as an index from 0 to (V−1) indicating corresponding SE ratio for given number of RBs (i) or equivalently number of subcarriers (N_{sc}=12i). By default, and regardless of number of subcarriers, “SEIndex” (refer it as SE_{I}) can be set to 0 (SE_{I}=0), indicating no spectral extension. The “SEIndex” for different numbers of scheduled subcarriers (N_{sc}) may indicate different SE ratio (SE). To support V number of different SE ratios, log₂(V) bits are required to signal a UE (e.g., through RRC or PDCCH or MAC-CE). For example, in one design, three-bit field could be allocated for “SEIndex” to indicate maximum V=8 different SE ratio for given number of scheduled subcarriers with range of 0≤SE_{I}≤V−1=7).

A look-up table could be defined and specified to map “SEIndex” (SE_{I}) to SE ratio (SE). In such table, a row index may represent “SEIndex” and column index may refer to number of RBs; each entry shows the SE ratio corresponding to i and SE_{I}. For example, for three-bit length “SEIndex,” TABLE 1 is depicting the structure of such look-up table. Where for column i (number of RBs is i), there are 8 different rows, each representing spectral extension ratio (SE) corresponding to SE_{I} and i.

In other words, SE=S_{i,SE}_{_{I}} is showing the spectral extension ratio of i number of RBs and “SEIndex” of SE_{I} equals to S_{i,SE}_{_{I}}. To accommodate scenarios that V is greater than number of feasible “SEIndex” for given number of RB, most significant Bit, MSB (or least significant bit, LSB) of “SEIndex” may be ignored in look-up table for those number of RBs.

TABLE 1
Look-up table for three-bit length “SEIndex” (SE_{I})

| SE_{I} (integer) | SE_{I} (bit mapping) | i |
|---|---|---|
| 0 | 000 | SE = S_{i, 0} |
| 1 | 001 | SE = S_{i, 1} |
| 2 | 010 | SE = S_{i, 2} |
| 3 | 011 | SE = S_{i, 3} |
| 4 | 100 | SE = S_{i, 4} |
| 5 | 101 | SE = S_{i, 5} |
| 6 | 110 | SE = S_{i, 6} |
| 7 | 111 | SE = S_{i, 7} |

An example of look-up table for a number of RBs (1, 2, 3) is shown in TABLE 2. For instance, “SEIndex” of 1 and 2 may map to 1/11 SE ratio and 1/5 SE ratio, respectively, when 2 RBs are allocated; while same “SEIndex” of 1 and 2 may map to 1/8 SE ratio and 1/5 SE ratio, respectively, when 3 RBs are allocated. In this example design, MSB for RB number of 1 and 2 are ignored.

TABLE 2
An example of look-up table to map 3 bit “SEIndex”
to SE ratio for given number of scheduled RBs
(i = 1, 2, 3); MSB is ignored for i = 1, 2

| SE_{I} (integer) | SE_{I} (bit mapping) | i = 1 | i = 2 | i = 3 |
|---|---|---|---|---|
| 0 | 000 | SE = 0 | SE = 0 | SE = 0 |
| 1 | 001 | SE = 1/5 | SE = 1/11 | SE = 1/17 |
| 2 | 010 | SE = 1/2 | SE = 1/5 | SE = 1/8 |
| 3 | 011 | SE = 1 | SE = 1/3 | SE = 1/5 |
| 4 | 100 | SE = 0 | SE = 1/2 | SE = 1/3 |
| 5 | 101 | SE = 1/5 | SE = 5/7 | SE = 5/13 |
| 6 | 110 | SE = 1/2 | SE = 1 | SE = 1/2 |
| 7 | 111 | SE = 1 | SE = 1 | SE = 1 |

In another example, TABLE 3, for RB 1 and 2, some of “SEIndex” values are not mapped to any SE ratio (hence may not be allowed).

TABLE 3
An example of look-up table to map 2 bit “SEIndex” to SE
ratio for given number of scheduled RBs (i = 1, 2, 3)

| SE_{I} (integer) | SE_{I} (bit mapping) | i = 1 | i = 2 | i = 3 |
|---|---|---|---|---|
| SE_{I} = 0 | 000 | SE = 0 | SE = 0 | SE = 0 |
| SE_{I} = 1 | 001 | SE = 1/5 | SE = 1/11 | SE = 1/17 |
| SE_{I} = 2 | 010 | SE = 1/2 | SE = 1/5 | SE = 1/8 |
| SE_{I} = 3 | 011 | SE = 1 | SE = 1/3 | SE = 1/5 |
| SE_{I} = 4 | 100 | — | SE = 1/2 | SE = 1/3 |
| SE_{I} = 5 | 101 | — | SE = 5/7 | SE = 5/13 |
| SE_{I} = 6 | 110 | — | SE = 1 | SE = 1/2 |
| SE_{I} = 7 | 111 | — | — | SE = 1 |

An SE ratio can be formulated as follows:

$$SE = \frac{2 {N}_{se}}{{N}_{data}} = \frac{2 {N}_{se}}{{N}_{sc} - 2 {N}_{se}} = \frac{{N}_{se}}{6 i - {N}_{se}} .$$

Typically, A SE ratio may range from 0 to 1, but it is still possible to have larger than 1 as SE ratio: (1) it can be shown that for any RB size, SE ratio of 0, 1/5, 1/2 and 1 are feasible, achieving low SE and high SE; (2) for any even-size RB 0≡i (mod 2), SE=1/11, 1/5, 1/3, 1/2, 5/7, 1 could be applied (ignored SE ratios larger than 1); and/or (3) for any RB size that 0≡i (mod 3), following SE rates could be feasible SE=1/17, 1/8, 1/5, 1/3, 5/13,1/2, 7/11, 4/5,1 (ignored SE ratios larger than 1).

As it can be seen, for different number of RBs, feasible SE ratios could be different and hence “SEIndex” may indicate different SE ratio. In other words, a look-up table maps the number of RBs and “SEIndex” to specific SE ratios.

TABLE 4 illustrates some of the feasible values of SE ratio for different RB sizes, and how three-bit “SEIndex” is mapped to some or all of feasible SE ratios (based on TABLE 3). As can be seen from TABLE 4, for RB size of 1 and 2, there are “SEIndex” that are not mapped (“SEIndex” 4-7 for RB i=1 and “SEIndex” 7 for RB i=2) while for RB size i=3, there are SE ratios of 7/11 and 4/5 that are not mapped to any “SEIndex.” Standard may specify number of bits dedicated for “SEIndex” as well as look-up table for “SEIndex” mapping based on number of RBs.

TABLE 4
An example of feasible SE ratios as function of number of RBs 1-3 and corresponding
three-bit length “SEIndex” mapping to SE ratio

| RB | 1 | | | | 2 | | | | | | | 3 | | | | | | | | | |
|---|---|---|---|---|---|---|---|---|---|---|---|---|---|---|---|---|---|---|---|---|---|
| N_{sc} | 12 | | | | 24 | | | | | | | 36 | | | | | | | | | |
| SE ratio | 0 | $\frac{1}{5}$ | $\frac{1}{2}$ | 1 | 0 | $\frac{1}{11}$ | $\frac{1}{5}$ | $\frac{1}{3}$ | $\frac{1}{2}$ | $\frac{5}{7}$ | 1 | 0 | $\frac{1}{17}$ | $\frac{1}{8}$ | $\frac{1}{5}$ | $\frac{2}{7}$ | $\frac{5}{13}$ | $\frac{1}{2}$ | $\frac{7}{11}$ | $\frac{4}{5}$ | 1 |
| SE_{I} | 0 | 1 | 2 | 3 | 0 | 1 | 2 | 3 | 4 | 5 | 6 | 0 | 1 | 2 | 3 | 4 | 5 | 6 | — | — | 7 |
| 2Nₛₑ | 0 | 2 | 4 | 6 | 0 | 2 | 4 | 6 | 8 | 10 | 12 | 0 | 2 | 4 | 6 | 8 | 10 | 12 | 14 | 16 | 18 |
| N_{data} | 12 | 10 | 8 | 6 | 24 | 22 | 20 | 18 | 16 | 14 | 12 | 36 | 34 | 32 | 30 | 28 | 26 | 24 | 22 | 20 | 18 |

In another design, “SEIndex” can be mapped to SE ratio regardless of a number of RBs. TABLE 5 illustrates an example of such mapping between three-bit length “SEindex” and 8 example values for SE ratio.

TABLE 5
RB independent mapping of SEIndex and SE ratio

| SE_{I} | SE |
|---|---|
| 0 | 0 (0%) |
| 1 | 1/17 ≅ 5.8% |
| 2 | 1/11 ≅ 9% |
| 3 | 1/8 ≅ 12.5% |
| 4 | 1/5 = 20% |
| 5 | 2/7 ≅ 28% |
| 6 | 4/5 = 80% |
| 7 | 1 = 100% |

With this design, a UE or a BS could calculate Nse, based on following equation 1.

$${N}_{se} = ⌊ \frac{{N}_{sc} SE}{2 ( 1 + SE )} ⌋ \qquad Equation 1$$

In Equation 1, └ ┘ is a floor function. With this design, for some cases, two or more different “SEindex”s may have same number of spectrally extended subcarriers for given number of RBs; as result, the effective SE ratio could become equal or slightly different than SE. TABLE 6 illustrates an example for scheduled RBs i=6 (N_{sc}=72); the number of extended subcarriers (2Nₛₑ) can be calculated using Equation 1 and shown in TABLE 5. As it can be seen for this example, the effective SE ratio for all of “SEIndex” is same as SE ratio.

TABLE 6
An example of parameters for 6 RB case (72 subcarriers)
based on RB-independent look-up table

| | SE | N_{sc} | Nₛₑ | Effective SE ratio |
|---|---|---|---|---|
| SE_{I} = 0 | 0 (0%) | 72 | 0 | 0 |
| SE_{I} = 1 | 1/17 ≅ 5.8% | 72 | 2 | 1/17 |
| SE_{I} = 2 | 1/11 ≅ 9% | 72 | 3 | 1/11 |
| SE_{I} = 3 | 1/8 ≅ 12.5% | 72 | 4 | 1/8 |
| SE_{I} = 4 | 1/5 = 20% | 72 | 6 | 1/5 |
| SE_{I} = 5 | 2/7 ≅ 28% | 72 | 8 | 2/7 |
| SE_{I} = 6 | 4/5 = 80% | 72 | 16 | 4/5 |
| SE_{I} = 7 | 1 = 100% | 72 | 18 | 1 |

In another example (e.g., TABLE 7), a number of subcarriers is 48, and can be seen some of “SEIndex” may have slightly different effective SE than SE ratio. Also, can be seen that “SEIndex” 2 and 3 for this case may have same number of spectrally extended subcarriers and same effective SE ratio.

TABLE 7
An example of parameters for 4 RB case (48 subcarriers)
based on RB-independent look-up TABLE 5

| | SE | N_{sc} | Nₛₑ | Effective SE ratio |
|---|---|---|---|---|
| SE_{I} = 0 | 0 (0%) | 48 | 0 | 0 |
| SE_{I} = 1 | 1/17 ≅ 5.8% | 48 | 1 | ≅4% |
| SE_{I} = 2 | 1/11 ≅ 9% | 48 | 2 | 1/11 ≅ 9% |
| SE_{I} = 3 | 1/8 ≅ 12.5% | 48 | 2 | 1/11 ≅ 9% |
| SE_{I} = 4 | 1/5 = 20% | 48 | 4 | 1/5 = 20% |
| SE_{I} = 5 | 2/7 ≅ 28% | 48 | 5 | ≅26% |
| SE_{I} = 6 | 4/5 = 80% | 48 | 10 | ≅83% |
| SE_{I} = 7 | 1 = 100% | 48 | 12 | 1 |

Different pulse shaping filters using well-established mathematical functions, such as cosine or exponential or hyperbolic functions, could be exploited for FDSS-DFT-s-OFDM with or without spectral extension. Moreover, AI-based techniques or numerical approaches could be utilized to obtain the FDSS filter tap values with objective of minimizing a loss function for given SE ratio and potentially FDSS structure.

Standard may specify FDSS filter taps on one or more of the following ways: (1) closed form equations (e.g., root raised cosine (RRC), exponential, hyperbolic or polynomial coefficients, etc.); (2) frequency domain tap values of FDSS for reference number of subcarriers; and/or (3) time domain tap values of FDSS.

Some examples for AI-based pulse shaping (depending on FDSS structure and technique to obtain FDSS taps) are: (1) TD-Filter: when time domain (TD) tap values of FDSS is specified in standard; (2) Poly-ISI-Free-Flat: polynomial coefficients is utilized to calculate FDSS taps with ISI-free-flat structure; (3) Poly-Flat: polynomial coefficients is utilized to calculate FDSS taps with flat pass-band structure; (4) Poly-Non-Flat: polynomial coefficients is utilized to calculate FDSS taps with non-flat passband structure; (5) FD-ISI-Free-Flat: frequency domain (FD) tap values of FDSS is utilized to calculate FDSS taps with ISI-free flat structure; (6) FD-Flat: frequency domain tap values of FDSS is utilized to calculate FDSS taps with flat structure; and/or (7) FD-Non-Flat: frequency domain tap values of FDSS is utilized to calculate FDSS taps with Non-flat structure.

Therefore, a UE or a BS may perform some additional procedures to extract and adapt the exact frequency domain tap values for each abovementioned approach to a number of allocated/scheduled RBs.

“FDSSTypeIndex” can be defined as an index from 0 to (T−1) indicating specific FDSS filter. By default, “FDSSTypeIndex” (refer it as T_{I}) can be set to 0 (T_{I}=0), indicating rectangular pulse-shaping. To support T number of different FDSS types, log₂(T) bits are required to signal a UE (e.g., through RRC or PDCCH or MAC-CE). For example, three-bit field could be allocated for “FDSSTypeIndex” to indicate maximum T=8 different filter shapes with range of 0≤T_{I}≤T−1=7). For an example, T_{I}=1 could refer to RRC, T_{I}=2 could refer to specific filter that is optimized in numerical fashion, T_{I}=3 may refer to specific TD Filter and etc.

For configuring/reconfiguring of FDSS by a network (NW), a UE may need to know both “FDSSTypeIndex” and “SEIndex.” In one design, NW explicitly signals UE on both “FDSSTypeIndex” and “SEIndex.” For example, if three-bit length “FDSSTypeIndex” and three-bit length “SEIndex” are utilized, 8 different FDSS type/shape and 8 different SE ratio could be supported. Hence, the total number of combinations is 64. TABLE 8 is an example design for case of two-bit length “SEIndex” and three-bit length “FDSSTypeIndex.” In TABLE 8 only “FDSSTypeIndex” from 0 to 4 are shown (5 to 7 are not shown). “FDSSTypeIndex” and “SEIndex” define FDSS type and SE ratio, respectively and the UE may utilize FDSS type/shape-specific procedures to construct FDSS taps for scheduled number of subcarriers. Three examples are given for three different FDSS types, Poly-Non-Flat, FD-Non-Flat, TD-Filter (equivalently “FDSSTypeIndex” 2, 3, 4 based on example TABLE 8).

For example, a time domain filter taps h=[h₀, . . . , h_{Z-1}] (Z is number of time domain taps) can be defined for “FDSSTypeIndex” 4 and specific spectral extension ratio 1/2 (mapped to “SEIndex”), hence a UE could calculate N_{sc} frequency domain filter taps based on Fourier transform as follows:

$${F}_{k + 1} = {\sum }_{z = 0}^{Z - 1} {h}_{z} {e}^{- j \frac{2 π}{{N}_{SC}} k z} , 0 \leq k \leq {N}_{SC} - 1. \qquad Equation 2$$

In another example, “Poly-Non-Flat” is provided where D^{th} order polynomial design (e.g. D=10) for non-flat structure with N_{sc_ref}=384, N_{se_ref}=19,

$$SE = \frac{19}{173}$$

under QPSK modulation can be specified as following polynomial coefficients, a₀=0.00918057, a₂=−0.00687915, a₄=−0.118361, a₆=0.944597, a₈=−0.905439, a₁₀=−4.68289. The coefficients can define G(b) for b=0,1, . . . , N_{sc}/2−1 as follows: G(b)=Σ_{d=0, . . . , D}a_{d}s(b)^{d} where s(0), . . . , s(N_{sc}/2−1) is the support vector representing equally spaced values with step-size of

$$\frac{2}{{N}_{s c} / 2 - 1}$$

over interval [−1, +1], and b^{th} element (b=0, . . . , N_{sc}/2−1) of support vector can be calculated as

$$s ( b ) = - 1 + \frac{2 b}{{N}_{s c} / 2 - 1} .$$

Once G(b) for b=0,1, . . . , N_{sc}/2−1 is calculated, the complete FDSS can be constructed based on following equation (using non-flat structure of filter):

$${F}_{k} = \{ \begin{matrix}G ( - k + {N}_{s c} / 2 ) , 1 \leq k \leq {N}_{s c} / 2 \\ G ( k - 1 - {N}_{s c} / 2 ) , {N}_{s c} / 2 + 1 \leq k \leq {N}_{s c}\end{matrix} . \qquad Equation 3$$

In another example, “FDSSTypeIndex” is FD-Non-Flat, a reference number of taps, Pₖ for k=1, . . . , N_{sc_ref}/2 can be specified in standard for given spectral extension ratio and for reference number of subcarriers, N_{sc_ref}. An arbitrary number of taps with size of N_{sc}/2 (Tₖ for k=1, . . . , N_{sc}/2) can be generated from resampling reference tap values. For this purpose, the ratio

$$\frac{{N}_{sc}}{{N}_{sc \_ ref}}$$

can be simplified to a rational number L/M, i.e.

$$\frac{{N}_{sc}}{{N}_{sc \_ ref}} = \frac{L}{M} .$$

This is accomplished by L-fold up-sampling, followed by low-pass filtering and then M-fold down sampling.

L-fold up-sampling: Wₖ for k=1, . . . , L*N_{sc_ref}/2, are up-sampled parameters of reference taps (P) and is calculated as follows:

$${W}_{k} = \{ \begin{matrix}{P}_{k / L} , & if k / L is integer \\ 0 , & otherwise\end{matrix} .$$

In one embodiment, a low-pass filtering is provided. In such embodiment, an output of L-fold up-sampling (W) goes through ideal low-pass filter via convolution operation (or equivalently multiplication for Fourier transform of W) as follows, Eₖ=convolution(W, 2f_{c}sinc(2f_{c}k)) where

$${f}_{c} = min ( \frac{1}{2 L} , \frac{1}{2 M} ) .$$

In one embodiment, an M-fold down-sampling is provided. In such embodiment, a number of samples is reduced from LN_{p_ref} to Nₚ by discarding M−1 samples for every M samples in the original sequence, i.e., Uₖ=E_{Mk} for k=1, . . . , Nₚ.

In one embodiment, a constructing FDSS is provided. In such embodiment, once Nₚ taps (Uₖ for k=1, . . . , Nₚ) are obtained, they can be mapped to subcarrier indexes k according to following equation, Uₖ, k=1, . . . ,

$${N}_{p} = G ( k - 1 - \frac{{N}_{s c}}{2} ) , \frac{{N}_{s c}}{2} + 1 \leq k \leq {N}_{s c} .$$

Then, Equation 2 can be utilized to construct a complete FDSS as G(b), b=0, . . . , N_{sc}/2−1 is determined.

For example, if N_{sc_ref}=120, and SE=20%, N_{sc}=240 are selected by a NW and FD-Non-Flat structure is utilized,

$$\frac{{N}_{s c}}{{N}_{sc \_ ref}} = \frac{L}{M} ,$$

L=4 and M=3; first Pₘ, m=1, . . . , 60, is up sampled by 4 and resulting on 240 samples; after convolution with ideal low pass filter with

$${f}_{c} = \frac{1}{8} ,$$

the resultant samples are down sampled by 3 and becomes 80 samples corresponding to target FDSS taps for taps 81≤k≤160. By utilizing Equation 2, full FDSS can be constructed.

In another design example, a NW signals a UE on an SE ratio and utilized FDSS using “FDSSIndex” which could be defined as an index combining “FDSSTypeIndex” and “SEIndex.” In this design, only “FDSSIndex” is signaled and the UE could obtain “FDSSTypeIndex” and “SEIndex” indirectly. For example, 6-bit length of “FDSSIndex” could allow 64 different combination of “FDSSTypeIndex” and “SEIndex.” In TABLE 8, “FDSSIndex” are mapped and can be utilized instead of “FDSSTypeIndex” and “SEIndex.”

When a FDSS-DFT-s-OFDM is enabled for a UE to transmit a transport block on PUSCH or PUCCH or DMRS, the “FDSSIndex” or “FDSSTypeIndex” and “SEIndex” provide the UE adequate information on the FDSS shape/type and “SEIndex.” Then, the UE based on number of scheduled RBs (in case of RB dependent look-up table) and corresponding SEIndex could figure out the exact SE ratio and FDSS tap values for reference filter. By default, rectangular FDSS with zero percent SE ratio is utilized; i.e., “FDSSTypeIndex” equals to zero and “SEIndex” equals to zero (equivalent to “FDSSIndex” equals to zero).

TABLE 8
An example for designs with FDSS types and SE ratios as well as FDSS indexes

| FDSSTypeIndex | 0 | 1 | | | | 2 | | | | 3 | | | | 4 | | | |
|---|---|---|---|---|---|---|---|---|---|---|---|---|---|---|---|---|---|
| FDSSType | Rectangular | RRC | | | | Poly-Non-Flat | | | | FD-Non-Flat | | | | TD Filter | | | |
| | Fitter (default) | | | | | | | | | | | | | | | | |
| Definition | All-one vector | Closed form | | | | Polynomial | | | | Reference | | | | Time domain | | | |
| | | equation | | | | coefficients are | | | | frequency | | | | impulse | | | |
| | | | | | | given to model | | | | domain filter | | | | response of | | | |
| | | | | | | the frequency | | | | taps for | | | | filter is given | | | |
| | | | | | | domain of filter | | | | reference | | | | | | | |
| | | | | | | | | | | number of | | | | | | | |
| | | | | | | | | | | subcarriers are | | | | | | | |
| | | | | | | | | | | given | | | | | | | |
| SEIndex | 0 | 0 | 1 | 2 | 3 | 0 | 1 | 2 | 3 | 0 | 1 | 2 | 3 | 0 | 1 | 2 | 3 |
| FDSSIndex | 0 | 1 | 2 | 3 | 4 | 5 | 6 | 7 | 8 | 9 | 10 | 11 | 12 | 13 | 14 | 15 | 16 |

As illustrated in TABLE 8, “FDSSTypeIndex” and “SEIndex” are provided for defining the exact FDSS type and SE ratio. Or equivalently, “FDSSIndex” could be utilized.

In one embodiment, standard may specify a “fixed spectral extension ratio,” and once FDSS-based transmission is configured or enabled, a UE can transmit accordingly. With such design, a spectral extension ratio becomes transparent and no need for specific signaling of spectral extension ratio. Additionally, the UE or a BS could calculate Nₛₑ, similar to equation 4 (mentioned above):

$${N}_{s e} = ⌊ \frac{{N}_{sc} {SE}_{Fixed}}{2 ( 1 + {SE}_{Fixed} )} ⌋ . \qquad Equation 4$$

In Equation 4, SE_{Fixed} is a “fixed spectral extension ratio” and └ ┘ is a floor function. To achieve better trade-off between PAPR reduction and spectral efficiency, fixed spectral extension ratio could be agreed between around 10% and around 20%. With this design, the effective SE ratio could become equal or slightly different than SE_{Fixed}.

For example, for SE_{Fixed}=1/11, for different number of RBs, number of spectrally extended subcarriers 2Nₛₑ can be obtained. TABLE 9 illustrates Nₛₑ based on different values of 2N_{sc}. As it can be seen effective SE ratio for some cases are different than SE_{Fixed}=1/11.

TABLE 9
number of spectrally extended and effective
SE ratio for given SE_{Fixed} = 1/11

| N_{sc} | Nₛₑ | Effective SE ratio |
|---|---|---|
| 24 | 1 | 1/11 |
| 36 | 1 | 1/17 |
| 48 | 2 | 1/11 |
| 60 | 2 | 1/14 |
| 72 | 3 | 1/11 |
| 84 | 3 | 1/13 |

In one example, for SE_{Fixed}=1/5, for different number of RBs, number of spectrally extended subcarriers 2Nₛₑ can be obtained. TABLE 10 illustrates Nₛₑ based on different values of 2N_{sc}. As it can be seen effective SE ratio for all cases are same as SE_{Fixed}=1/5.

TABLE 10
A number of spectrally extended and effective
SE ratio for given SE_{Fixed} = 1/5

| N_{sc} | Nₛₑ | Effective SE ratio |
|---|---|---|
| 24 | 2 | 1/11 |
| 36 | 3 | 1/11 |
| 48 | 4 | 1/11 |
| 60 | 5 | 1/11 |
| 72 | 6 | 1/11 |
| 84 | 7 | 1/11 |

In one embodiment, standard may not specify FDSS type, and in case the DMRS is transmitted by FDSS-SE, the receiver combines symbols according to the values of the channel estimation. With such design, a FDSS type becomes transparent and no need for specific signaling of FDSS. This has advantages of no specific signaling, however in some cases the performance could be lower than case where FDSS signaled between a UE and a BS.

In order for NW, to know whether a target UE supports FDSS-DFT-s-OFDM or not, the UE may compile and transfer its UE capability information upon receiving a UECapabilityEnquiry from a BS. The UE may set the contents of UECapabilityInformation message to reflect its support for FDSS-DFT-s-OFDM. To support FDSS-DFT-s-OFDM (e.g., AI or non-AI-based FDSS), signaling between the BS and the UE could be based on higher layer radio resource control (RRC) messages or downlink control information (DCI) in physical downlink control channel (PDCCH) messages or MAC control element (MAC-CE).

FIG. 8 illustrates a flowchart of UE capability exchange 800 for FDSS based on an RRC message according to embodiments of the present disclosure. The UE capability exchange 800 may be performed by a UE (e.g., 111-116 as illustrated in FIG. 1) and a BS (e.g., 101-103 as illustrated in FIG. 1). An embodiment of the UE capability exchange 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

In case that, UEs with specific UE category are supporting FDSS-DFT-s-OFDM by default, there may no need for the UE capability exchange on FDSS between the UE and a NW; in such case, whenever DFT-S-OFDM is enabled, FDSS could be configured by a NW with appropriate fields. FIG. 8 illustrates an example of signaling 800 for UE capability support of FDSS based on DFT-s-OFDM via RRC. At signaling operation S801, the BS may inquire FDSS with spectral extension support by sending “FDSS-DFT-S-OFDM-Support” information element (IE) field. On response, based on S802, the UE could respond with “FDSS-Support” field to indicate whether the UE is supporting FDSS with spectral extension or not.

Once UE capability information is exchanged, and FDSS-DFT-s-OFDM is enabled by RRC, the “SEIndex” and “FDSSTypeIndex” (or in different design “FDSSIndex”) can be configured by one of the following ways: (1) a static/semi-static RRC configuration of FDSS; (2) a dynamic configuration of FDSS (via DCI in PDCCH messages); and (3) a semi-dynamic configuration of FDSS (via MAC-CE).

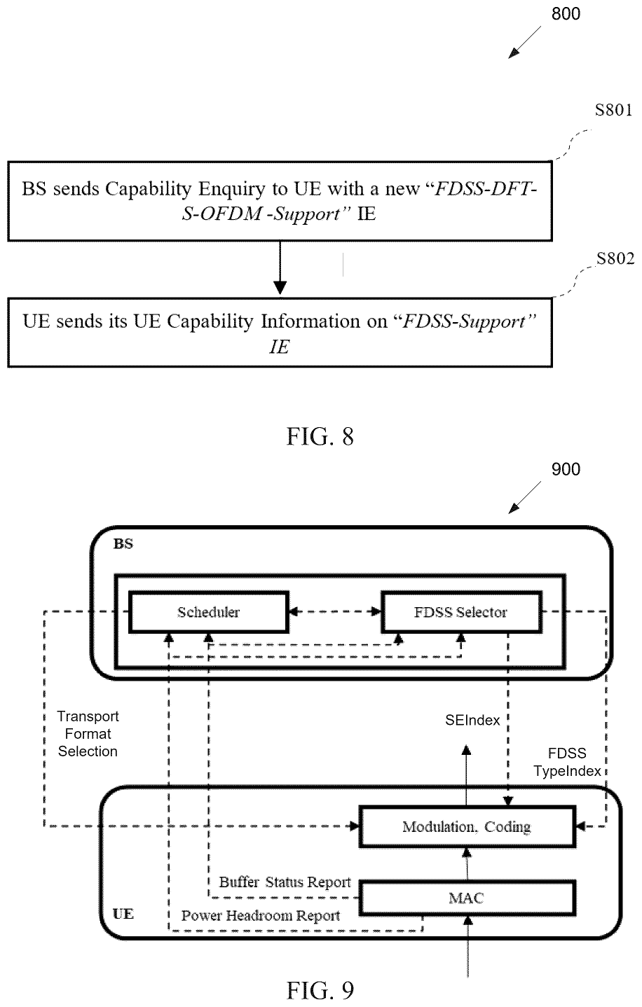

The FDSS Selector could be defined as functionality in a MAC layer or in an uplink scheduler or as a separate entity in radio access network, where a BS in each transmission time interval takes a dynamic decision on “SEIndex” and “FDSSTypeIndex” (or in different design “FDSSIndex”) and sends such information to the target UEs. However, there is also a possibility for semi-dynamic or static/semi-static decision is signaled in advance to reduce the control-signaling overhead. The FDSS selector and uplink scheduler could configure which UEs to utilize FDSS and, for each of these UEs, the set of resource blocks upon which the UE's uplink data may be transmitted using specific FDSS filter and SE ratio (selection of FDSSTypeIndex and SEIndex are controlled by the BS, as illustrated in the FIG. 9).

FIG. 9 illustrates an example of joint operation of FDSS selection and scheduler in uplink 900 according to embodiments of the present disclosure. An embodiment of the joint operation of FDSS selection and scheduler in uplink 900 shown in FIG. 9 is for illustration only.

An FDSS selector may consider some feedback from a UE on selecting FDSS. For example, in one design, FDSS selector may consider one or more of the following feedback information from the UE. For example: CSI, location of the UE, mobility, UE category, buffer status, power headroom reports, transport format selection (selection of transport-block size, modulation scheme, and antenna mapping) may be used to select “SEIndex” and “FDSSTypeIndex” (or in different design “FDSSIndex”).

In one embodiment, the FDSS selection decisions are taken per UE.

In another embodiment, the FDSS selection decisions may be taken for a group of UE's. For example, when the group of UEs have similar channel conditions, mobility patterns, power requirements etc.

Jointly, uplink scheduler and FDSS selector may control the data rate and the PAPR (or other characteristics of uplink signal) by scheduling and FDSS selection decisions.

In one embodiment, a BS configures/reconfigures a UE with “SEIndex” and “FDSSTypeIndex” (or in different design “FDSSIndex”). A configured UE initiates the uplink transmission with corresponding FDSS shape and SE ratio. Sametime, the BS may utilize corresponding FDSS shape and SE ratio at reception. The Information Element (IE) PUSCH/PUCCH-Config can be applied to enable/disable and configure/reconfigure the UE specific FDSS.

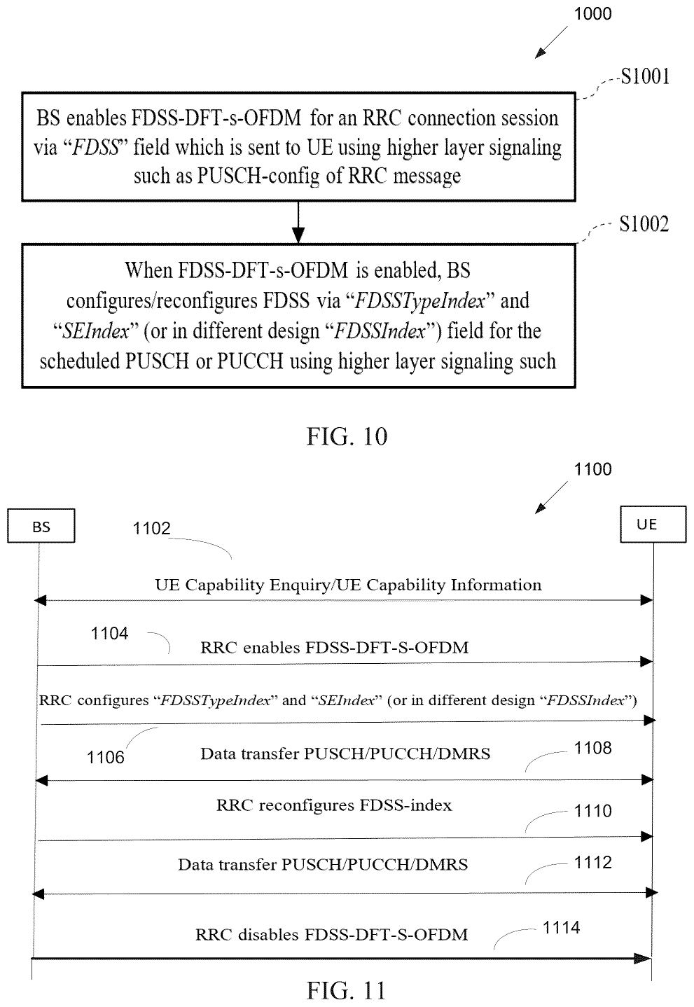

Once FDSS is enabled and configured, the UE may perform frequency domain filtering over PUSCH or PUCCH or DMRS based on constructed FDSS filter taps and SE ratio. FIG. 10 and FIG. 11 illustrate the signaling exchange to configure/reconfigure “FDSSIndex.” The FDSS-DFT-s-OFDM is enabled/disabled using single bit “FDSS” field.

FIG. 10 illustrates a flowchart of RRC signaling 1000 to configure/reconfigure FDSSTypeIndex and SEIndex according to embodiments of the present disclosure. The RRC signaling 1000 as may be performed by a BS (e.g., 101-103 as illustrated in FIG. 1). An embodiment of the RRC signaling 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, in step S1001, the BS enables FDSS-DFT-s-OFDM for an RRC connection session via FDSS which is sent to the UE using higher layer signaling such as PUSCH-config of RRC message. In step 1002, when FDSS-DFT-s-OFDM is enabled, the BS configures/reconfigures FDSS.

FIG. 11 illustrates a signaling flow of RRC signaling 1100 to configure/reconfigure FDSSTypeIndex and SEIndex according to embodiments of the present disclosure. The RRC signaling 1100 as may be performed by a UE (e.g., 111-116 as illustrated in FIG. 1) and a BS (e.g., 101-103). An embodiment of the RRC signaling 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, in step 1102, a BS and a UE establish the UE capability enquiry and the UE capability information. In step 1104, the BS sends an EEC enables FDSS-DFT-S-OFDM. In step 1106, the BS configures “FDSSTypeIndex” and “SEIndex” (or in different design “FDSSIndex”). In step 1108, the data transfer PUSCH/PUCCH/DMRS is performed between the BS and the UE. In step 1110, the BS reconfigures FDSS-index. In step 1112, data transfer PUSCH/PUCCH/DMRS is performed between the BS and the UE. In step 1114, the BS disables FDSS-DFT-S-OFDM.

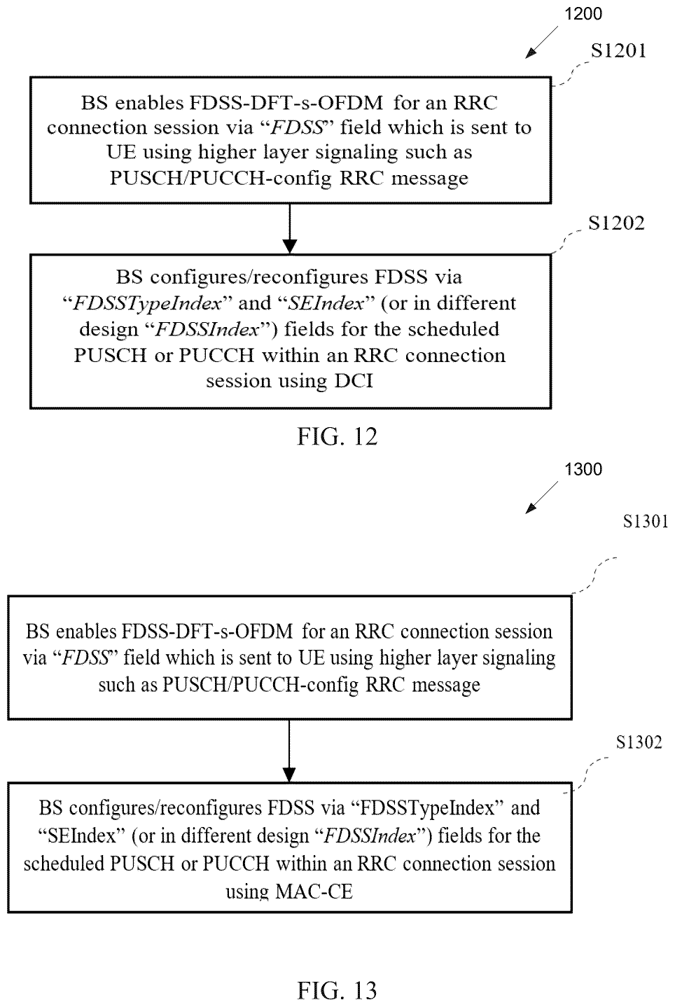

FIG. 12 illustrates a flowchart of RRC signaling to enable FDSSTypeIndex and SEIndex 1200 according to embodiments of the present disclosure. The RRC signaling to enable FDSSTypeIndex and SEIndex 1200 as may be performed by a BS (e.g., 101-103 as illustrated in FIG. 1). An embodiment of the RRC signaling to enable FDSSTypeIndex and SEIndex 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

FIG. 12 illustrates the signaling operation for an FDSS configuration via an RRC. At signaling operation S1201, the BS can either enable (or disable) FDSS with spectral extension by enabling new single bit “FDSS” field for a specific UE on uplink direction using higher layer RRC messages (PUSCH/PUCCH-config). Once the FDSS is enabled, on signaling operation S1202, the BS can configure “SEIndex” and “FDSSTypeIndex” (or in different design “FDSSIndex”) using corresponding fields on PUSCH/PUCCH-config RRC message.

In an uplink, the UE determines the resource block assignment in frequency domain using the resource allocation field of DCI (except for Msg.3 PUSCH initial transmission). In 5G standard, three uplink resource allocations type 0, type 1 and type 2 are defined where resource allocation type 0 is used for PUSCH transmission and transform precoding is disabled. The uplink resource allocation type 1 is used for PUSCH transmission regardless of whether transform precoding is enabled or disabled. When the scheduling PDCCH is received with allocation type 0, the UE can assume that FDSS-DFT-S-OFDM is disabled.

Moreover, the UE can assume that when PDCCH is received with DCI format 0_0, then uplink resource allocation type 1 is used where the resource block assignment information informs the UE of a set of contiguously allocated. In such case, FDSS-DFT-s-OFDM could be enabled.

The message transmitted via DCI on PDCCH is utilized to inform the UE in an RRC_CONNECTED state about FDSS-type and SE ratio. If the UE receives a DCI with “FDSSIndex” or equivalently “FDSSTypeIndex” and “SEIndex,” it means that the FDSS may change at the next PUSCH based on FDSS shape and SE ratio.

FIG. 12 illustrates the signaling operation for an FDSS configuration via a PDCCH. At signaling operation S1201, the BS can either enable or disable FDSS with spectral extension by enabling single bit new “FDSS” field for the specific UE on uplink direction using higher layer RRC messages (PUSCH/PUCCH-config). Once the FDSS is enabled, on signaling operation S1202, the BS configures/reconfigures FDSS via new “FDSSTypeIndex” and “SEIndex” (or in different design “FDSSIndex”) fields for the scheduled PUSCH or PUCCH, enabling dynamic switching between different FDSS shapes and SE ratios within an RRC connection session using DCI formats such as DCI_0_0/DCI_0_1.

A MAC-CE can be identified with reserved values in the logical channel ID (LCID) field, where the LCID value could be specified to indicate the “FDSSTypeIndex” and “SEIndex” (or in different design “FDSSIndex”). Both fixed-length and variable-length MAC-CEs could be supported. In one example, new MAC-CE “FDSSTypeIndex” and “SEIndex” (or in different design “FDSSIndex”) capability can be identified by a MAC PDU sub-header with a new LCID with a fixed size of 8 or 16 bits in PUSCH. A BS may send MAC-CE to configure/reconfigure “FDSSTypeIndex” and “SEIndex” (or in different design “FDSSIndex”).

FIG. 13 illustrates a flowchart of MAC-CE signaling 1300 to configure FDSSTypeIndex and SEIndex according to embodiments of the present disclosure. The MAC-CE signaling 1300 as may be performed by a BS (e.g., 101-103 as illustrated in FIG. 1). An embodiment of the MAC-CE signaling 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

FIG. 13 illustrates the signaling operation for a MAC-CE FDSS configuration. At signaling operation S1301, the BS can either enable or disable FDSS with spectral extension by enabling single bit new “FDSS” field for specific UE on uplink direction using higher layer RRC messages (PUSCH/PUCCH-config). Once the FDSS is enabled, on signaling operation 1302, the BS can configure “FDSSTypeIndex” and “SEIndex” (or in different design “FDSSIndex”) using corresponding fields on MAC-CE.

In all configuration methods, a NW can disable FDSS-DFT-s-OFDM via “FDSS” field which is sent to a UE using higher layer signaling such as PUSCH/PUCCH-config RRC message. Or by setting “FDSSTypeIndex” corresponding to rectangular and “SEIndex” to zero ore equivalently by setting “FDSSIndex” to zero.

Examples for vast use cases in downlink/uplink/TDD/FDD transmissions: (1) terrestrial and non-terrestrial networks and (2) tera Hertz (THz)/sub-THz.

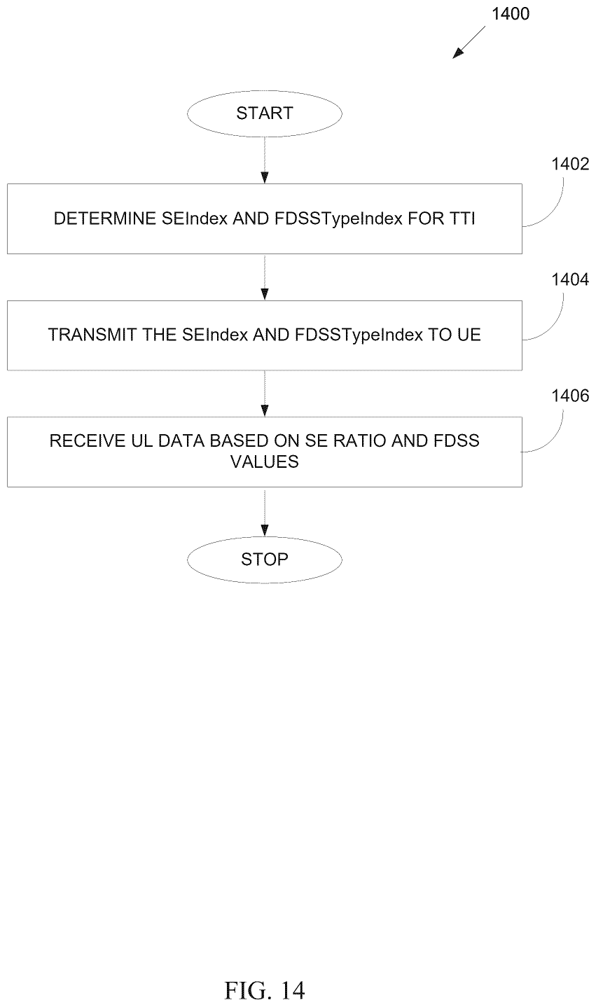

FIG. 14 illustrates a flowchart of a BS method 1400 for signaling pulse shaping in a wireless communication system according to embodiments of the present disclosure. The method 1400 as may be performed by a BS (e.g., 101-103 as illustrated in FIG. 1). An embodiment of the BS method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the BS method 1400 begins at step 1402. In step 1402, the BS determines an SEIndex and an FDSSTypeIndex for at least one TTI.

In one embodiment, the SEIndex and a number of scheduled RBs indicate a number of additional subcarrier.

In one embodiment, the FDSSTypeIndex indicates a type of FDSS filter for the UL data.

In one embodiment, a FDSS filter is configured based on the SEIndex, the FDSSTypeIndex, and the number of scheduled RBs.

In one embodiment, the SEIndex and the FDSSTypeIndex are transmitted via an RRC signaling, DCI, or a MAC CE.

In step 1404, the BS transmits, to a UE, the SEIndex and the FDSSTypeIndex.

In one embodiment, the SEIndex is determined based on a number of scheduled RBs.

In one embodiment, the SEIndex is determined independently of a number of scheduled RBs.

In step 1406, the BS receives, from the UE, UL data based on an SE ratio associated with the SEIndex and FDSS values. In such step, the FDSS values are associated with the FDSSTypeIndex.

In one embodiment, the BS receives, from the UE, feedback information including at least one of CSI, location information, mobility information, UE category information, buffer status information, power headroom reports, and transport format selection information. In such embodiment, the SEIndex and the FDSSTypeIndex are determined based on the feedback information.

In one embodiment, the BS selects the UE based on at least one of channel conditions, mobility patterns, and power requirements.

In one embodiment, the BS transmits, to the UE, a UE capability request to instruct the UE to send UE capability information indicating support for an FDSS-DFT-s-OFDM and receives, from the UE, the UE capability information indicating support for the FDSS-DFT-s-OFDM in response to transmitting the UE capability request.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A base station (BS) comprising:
a processor configured to determine a spectral extension index (SEIndex) and a frequency domain spectral shaping type index (FDSSTypeIndex) for at least one transmission time interval (TTI); and
a transceiver operably coupled to the processor, the transceiver configured to:
transmit, to a UE, the SEIndex and the FDSSTypeIndex, and
receive, from the UE, uplink (UL) databased on a spectral extension (SE) ratio associated with the SEIndex and frequency domain spectral shaping (FDSS) values,
wherein the FDSS values are associated with the FDSSTypeIndex.

2. The BS of claim 1, wherein:
the transceiver is further configured to receive, from the UE, feedback information including at least one of channel state information (CSI), location information, mobility information, UE category information, buffer status information, power headroom reports, and transport format selection information, and
the SEIndex and the FDSSTypeIndex are determined based on the feedback information.

3. The BS of claim 1, wherein the processor is further configured to select the UE based on at least one of channel conditions, mobility patterns, and power requirements.

4. The BS of claim 1, wherein the SEIndex is determined based on a number of scheduled resource blocks (RBs).

5. The BS of claim 1, wherein the SEIndex is determined independently of a number of scheduled resource blocks (RBs).

6. The BS of claim 1, wherein:
the SEIndex and a number of scheduled RBs indicate a number of additional subcarrier;
the FDSSTypeIndex indicates a type of FDSS filter for the UL data; and
a FDSS filter is configured based on the SEIndex, the FDSSTypeIndex, and the number of scheduled RBs.

7. The BS of claim 1, wherein the transceiver is further configured to:
transmit, to the UE, a UE capability request to instruct the UE to send UE capability information indicating support for a FDSS-discrete Fourier transform-spread-orthogonal frequency division (FDSS-DFT-s-OFDM); and
receive the UE capability information indicating support for the FDSS-DFT-s-OFDM in response to transmitting the UE capability request.

8. The BS of claim 1, wherein the SEIndex and the FDSSTypeIndex are transmitted via a radio resource control (RRC) signaling, downlink control information (DCI), or a medium access control control element (MAC CE).

9. A method performed by a base station (BS), the method comprising:
determining a spectral extension index (SEIndex) and a frequency domain spectral shaping type index (FDSSTypeIndex) for at least one transmission time interval (TTI);
transmitting, to a UE, the SEIndex and the FDSSTypeIndex; and
receiving, from the UE, uplink (UL) data based on a spectral extension (SE) ratio associated with the SEIndex and frequency domain spectral shaping (FDSS) values,
wherein the FDSS values are associated with the FDSSTypeIndex.

10. The method of claim 9, further comprising receiving, from the UE, feedback information including at least one of channel state information (CSI), location information, mobility information, UE category information, buffer status information, power headroom reports, and transport format selection information,
wherein the SEIndex and the FDSSTypeIndex are determined based on the feedback information.

11. The method of claim 9, further comprising selecting the UE based on at least one of channel conditions, mobility patterns, and power requirements.

12. The method of claim 9, wherein the SEIndex is determined based on a number of scheduled resource blocks (RBs).

13. The method of claim 9, wherein the SEIndex is determined independently of a number of scheduled resource blocks (RBs).

14. The method of claim 9, wherein:
the SEIndex and a number of scheduled RBs indicate a number of additional subcarrier;
the FDSSTypeIndex indicates a type of FDSS filter for the UL data; and
a FDSS filter is configured based on the SEIndex, the FDSSTypeIndex, and the number of scheduled RBs.

15. The method of claim 9, further comprising:
transmitting, to the UE, a UE capability request to instruct the UE to send UE capability information indicating support for a FDSS-discrete Fourier transform-spread-orthogonal frequency division (FDSS-DFT-s-OFDM); and
receiving, from the UE, the UE capability information indicating support for the FDSS-DFT-s-OFDM in response to transmitting the UE capability request.

16. The method of claim 9, wherein the SEIndex and the FDSSTypeIndex are transmitted via a radio resource control (RRC) signaling, downlink control information (DCI), or a medium access control control element (MAC CE).

17. A user equipment (UE) comprising:
a transceiver configured to receive, from a base station (BS), a spectral extension index (SEIndex) and a frequency domain spectral shaping type index (FDSSTypeIndex); and
a processor operably coupled to the transceiver, the processor configured to identify the SEIndex) and the FDSSTypeIndex for at least one transmission time interval (TTI), and
wherein the transceiver is further configured to transmit, to the BS, uplink (UL) data based on a spectral extension (SE) ratio associated with the SEIndex and frequency domain spectral shaping (FDSS) values associated with the FDSSTypeIndex.

18. The UE of claim 17, wherein:
the transceiver is further configured to transmit, to the BS, feedback information including at least one of channel state information (CSI), location information, mobility information, UE category information, buffer status information, power headroom reports, and transport format selection information; and
the SEIndex and the FDSSTypeIndex are determined based on the feedback information.

19. The UE of claim 17, wherein:
(i) the SEIndex is determined based on a number of scheduled resource blocks (RBs) or (ii) the SEIndex is determined independently of a number of scheduled resource blocks (RBs);
the SEIndex and a number of scheduled RBs indicate a number of additional subcarrier;
the FDSSTypeIndex indicates a type of FDSS filter for the UL data;
a FDSS filter is configured based on the SEIndex, the FDSSTypeIndex, and the number of scheduled RBs; and
the SEIndex and the FDSSTypeIndex are transmitted via a radio resource control (RRC) signaling, downlink control information (DCI), or a medium access control control element (MAC CE).

20. The UE of claim 17, wherein the transceiver is further configured to:
receive, from the BS, a UE capability request to instruct the UE to send UE capability information indicating support for a FDSS-discrete Fourier transform-spread-orthogonal frequency division (FDSS-DFT-s-OFDM); and
transmit, to the BS, the UE capability information indicating support for the FDSS-DFT-s-OFDM in response to transmitting the UE capability request.
